(19) United States
(12) Patent Application Publication
(10) Pub. No.: US 2012/0310748 A1
(43) Pub. Date: Dec. 6, 2012

(54) SYSTEM AND METHOD FOR MANAGING ADVERTISEMENTS BASED ON BENCHMARKING

(75) Inventor: Sung Bum Park, Seongnam-si (KR)

(73) Assignee: NHN BUSINESS PLATFORM CORPORATION, Seongnam-si (KR)

(21) Appl. No.: 13/303,616

(22) Filed: Nov. 23, 2011

(30) Foreign Application Priority Data
Nov. 24, 2010 (KR) 10-2010-0117476

(51) Int. Cl. G06Q 30/02

(52) U.S. Cl. 705/14.71; 705/14.4

(57) ABSTRACT

Provided is a system and method for managing advertisements. The advertising management system may transfer information about advertising indices of other advertisers to be benchmarked to advertisers who are inexperienced in advertising management and may automatically modify bidding information of the inexperienced advertisers based on the advertising indices of the other advertisers, thereby preventing the inexperienced advertisers from leaving the search advertisement market.

### CROSS-REFERENCE TO RELATED APPLICATION

This application claims priority from and the benefit of Korean Patent Application No. 10-2010-0117476, filed on Nov. 24, 2010, which is hereby incorporated by reference for all purposes as if fully set forth herein.

### BACKGROUND

1. Technical Field

Exemplary embodiments of the present invention relate to a system and method for managing advertisements, and more particularly, to a system and method for managing advertisements that may benchmark advertising indices of advertisers who are experienced in advertising management, and may manage advertisements of advertisers who are inexperienced is in advertising management.

2. Discussion of the Background

With the development of online advertisement markets, an increasing number of advertisers are now interested in online advertisements. Advertisers may need to access a system for managing online advertisements and to register their advertisements with the system. In this instance, an advertiser may need to directly set a variety of options to begin online advertisements, which allows different adverting effects depending on an experience or skillfulness of the advertiser.

In particular, a keyword advertisement requires an advertiser to register a keyword associated with a type of business of the advertiser, and to set a bid amount for each advertisement. However, advertisers who have newly started online advertisements may not be familiar with various options involved in keyword advertisements and thus, may experience difficulties in managing and operating advertisements. Due to this, the advertiser may not fully exploit the benefit of advertisements, which may potentially damage the advertiser and ultimately result in the advertiser's withdrawal from the online advertisement service.

Accordingly, there is a need for a method that enables even advertisers who have newly started online advertisements or advertisers who are inexperienced in advertising management to more easily participate into the online advertisements.

### SUMMARY

Exemplary embodiments of the present invention provide a system and method that may provide convenience for advertising management by providing a beginner advertiser who is inexperienced in advertising management with an advertising index of an advertiser or an advertiser group to be benchmarked.

Exemplary embodiments of the present invention also provide a system and method that enables a beginner advertiser who is inexperienced in advertising management to repeatedly place automatic bids based on an advertising index of an advertiser or an advertiser group to be benchmarked and thereby prevent the beginner advertiser from withdrawing from an advertising management system and enable the beginner advertiser to effectively manage advertisements.

Additional features of the invention will be set forth in the description which follows, and in part will be apparent from the description, or may be learned by practice of the invention.

An exemplary embodiment of the present invention provides a system for managing advertisements, including one or more non-transitory computer readable storage devices including a registration unit and an updated information providing unit, wherein the registration unit is configured to register a second advertiser to be benchmarked in association with advertising management of a first advertiser, and the updated information providing unit is configured to provide the first advertiser with updated information about an advertising index of the second advertiser.

Another exemplary embodiment of the present invention provides system for managing advertisements, including one or more non-transitory computer readable storage devices including a registration unit and a modification unit, wherein the registration unit is configured to register a second advertiser to be benchmarked in association with advertising management of a first advertiser, and the modification unit is configured to modify a bidding term of the first advertiser based on an advertising index of the second advertiser.

Still another exemplary embodiment of the present invention provides a method for managing advertisements using a processor, including registering a second advertiser to be benchmarked in association with advertising management of a first advertiser, updating information about an advertising index of the second advertiser using the processor, and providing the first advertiser with the updated information about the advertising index of the second advertiser.

Yet another exemplary embodiment of the present invention provides a method for managing advertisements using a processor, including registering a second advertiser to be benchmarked in association with advertising management of a first advertiser, and modifying, using the processor, a bidding term of the first advertiser based on the advertising index of the second advertiser.

Yet another exemplary embodiment of the present invention provides a method for managing advertisements using a processor, including receiving a request from a first advertiser for provision of information on a reference advertiser in association with advertising management of the first advertiser, registering the reference advertiser, updating information about an advertising index of the reference advertiser using the processor, and providing the first advertiser with the updated information about the advertising index of the reference advertiser.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram that illustrates a configuration of an advertising management system according to an exemplary embodiment of the present invention.

FIG. 2 is a block diagram that illustrates a configuration of an advertising management system according to another exemplary embodiment of the present invention.

FIG. 3 is a diagram that illustrates a process of registering an advertiser or an advertiser group to be benchmarked according to an exemplary embodiment of the present invention.

FIG. 4 is a diagram that illustrates a process of making automatic bids when an advertiser to be benchmarked newly places a bid for a keyword according to an exemplary embodiment of the present invention.

FIG. 5 is a diagram that illustrates a process of making automatic bids based on an advertising index of an advertiser to be benchmarked according to an exemplary embodiment of the present invention.

FIG. 6 is a flowchart that illustrates an advertising management method according to an exemplary embodiment of the present invention.

FIG. 7 is a flowchart that illustrates an advertising management method according to another exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements. Throughout the drawings and the detailed description, unless otherwise described, the same drawing reference numerals are understood to refer to the same elements, features, and structures. The relative size and depiction of these elements may be exaggerated for clarity, illustration, and convenience.

It should be understood that when an element is referred to as being “connected to” another element, it can be directly connected to the other element, or intervening elements may be present. It should also be understood that any element, operation or command described herein is not to be construed as being an essential or principle feature of the present disclosure unless otherwise explicitly described. As used herein, the singular forms “a”, “an” and “the” are intended to include the plural forms as well unless otherwise indicated. If only a single item is intended, the term “one” or similar terms will be used herein.

Hereinafter, exemplary embodiments of the present invention will be described with reference to the accompanying drawings.

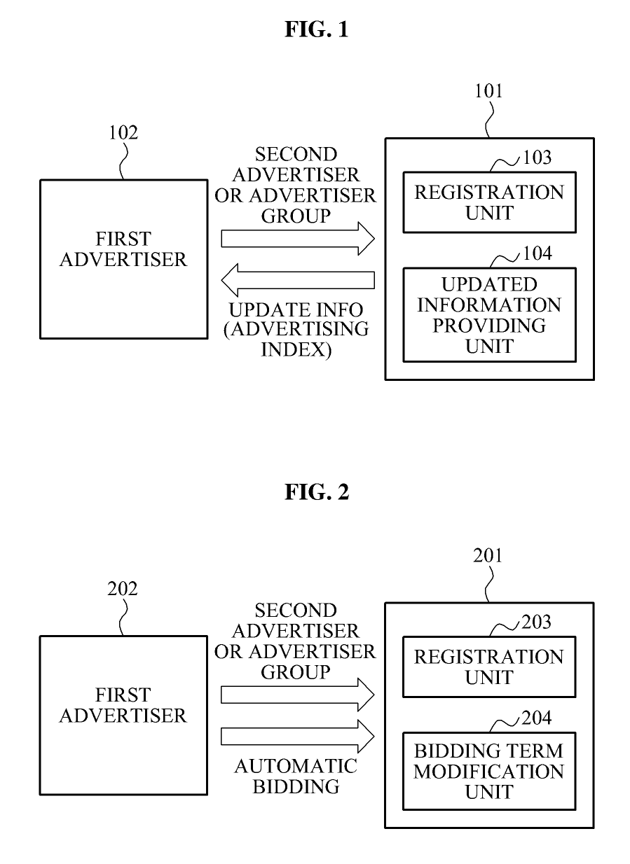

FIG. 1 is a block diagram that illustrates a configuration of an advertising management system 101 according to an exemplary embodiment of the present invention.

Referring to FIG. 1, the advertising management system 101 may include a registration unit 103 and an updated information providing unit 104.

The registration unit 103 may register at least one of a second advertiser and/or an advertiser group to be benchmarked in association with advertising management of a first advertiser 102. The first advertiser 102 may be an advertiser who has newly started advertising management or is inexperienced in the advertising management. The first advertiser 102 may also be an advertiser who is experienced in advertising management to some extent but who desires to benchmark an advertiser who is more experienced in advertising management. Accordingly, the first advertiser 102 may be an advertiser who designates the second advertiser or the advertiser group to be benchmarked in association with advertising management of the first advertiser 102. The second advertiser may be an advertiser to be benchmarked and the advertiser group may include a plurality of second advertisers.

The registration unit 103 may register at least one of the second advertiser and/or the advertiser group in association with a type of business of the first advertiser 102. For example, when the type of business of the first advertiser 102 is a “medical practice”, the second advertiser or the advertiser group may be associated with the “medical practice”. The registration unit 103 may extend the range of the second advertiser or the advertiser group to be a type of business unrelated to the type of business of the first advertiser 102 and thereby register the extended range of the second advertiser or the advertiser group. In this case, since information about other types of businesses that are not similar to the type of business of the first advertiser 102, as well as similar types of businesses, may be provided, excellent examples of advertisers or advertiser groups belonging to other types of businesses may be utilized.

The registration unit 103 may register the second advertiser and/or the advertiser group that satisfies the conditions for carrying out advertisement of the first advertiser 102. That is, an advertiser or an advertiser group that satisfies certain conditions may be a benchmarking target of the first advertiser 102. Here, the conditions for carrying out advertisement may be determined based on at least one of a monetary amount associated with the advertisement, a click through rate (CTR), a purchase rate, and a pay per click (PPC). For example, the advertiser or the advertiser group of which the monetary amount associated with the advertisement is within top 10%, the advertiser or the advertiser group of which the CTR is within top 20%, the advertiser or the advertiser group of which the number of clicks is within top 30%, the advertiser or the advertiser group of which the purchase rate is within top 15%, and the advertiser or the advertiser group of which the PPC is within top 20% may be a benchmarking target of the first advertiser 102. The registration unit 103 may include a storage device that stores advertisement-related information which is related to the second advertiser and/or the advertiser group which is relevant to the advertisement management by the first advertiser 102. Such advertisement-related information may include information about an advertising index of the second advertiser or the advertiser group, which will be described later. The advertisement-related information may be the advertising index of the second advertiser or the advertiser group itself.

The updated information providing unit 104 may provide the first advertiser 102 with updated information about an advertising index of the second advertiser or the advertiser group. For example, the updated information providing unit 104 may provide the updated information about the advertising index of the second advertiser or the advertiser group. The advertising index may be an index such as the number of registered keywords, the number of auctioned keywords, a CTR, the number of clicks, a purchase rate, and a PPC.

Specifically, every time the advertising index of the second advertiser or the advertiser group is modified, the updated information providing unit 104 may provide updated information about the advertising index. Every time at least a certain level of change occurs in the advertising index of the second advertiser or the advertiser group, the updated information providing unit 104 may provide updated information about the advertising index. The updated information providing unit 104 may provide updated information about the advertising index of the second advertiser or the advertiser group at certain time intervals.

The first advertiser 102 may manage his or her own advertisement scheme based on the updated information about the advertising index of the second advertiser or the advertiser group.

FIG. 2 is a block diagram that illustrates a configuration of an advertising management system 201 according to another exemplary embodiment of the present invention.

Referring to FIG. 2, the advertising management system 201 may include a registration unit 203 and a bidding term modification unit 204.

The registration unit 203 may register at least one of a second advertiser and/or an advertiser group to be benchmarked in association with advertising management of a first advertiser 202. Since descriptions related with the first advertiser 202, the second advertiser, and the advertiser group have been given above with reference to FIG. 1, further descriptions related thereto will be omitted here.

The bidding term modification unit 204 may modify one or more bidding terms, such as bidding terms of the first advertiser 202, based on an advertising index of the second advertiser or the advertiser group. For example, the bidding term modification unit 204 may enable the first advertiser 202 to place automatic bids until an advertising index of the first advertiser 202 approaches the advertising index of the second advertiser or the advertiser group. Here, the advertising index may be an index such as the number of registered keywords, the number of auctioned keywords, a CTR, the number of clicks, a purchase rate, and a PPC. That is, the advertising management system 201 may perform a mirroring function by managing an advertisement of the first advertiser 202 using a scheme similar to a scheme of the second advertiser or the advertiser group.

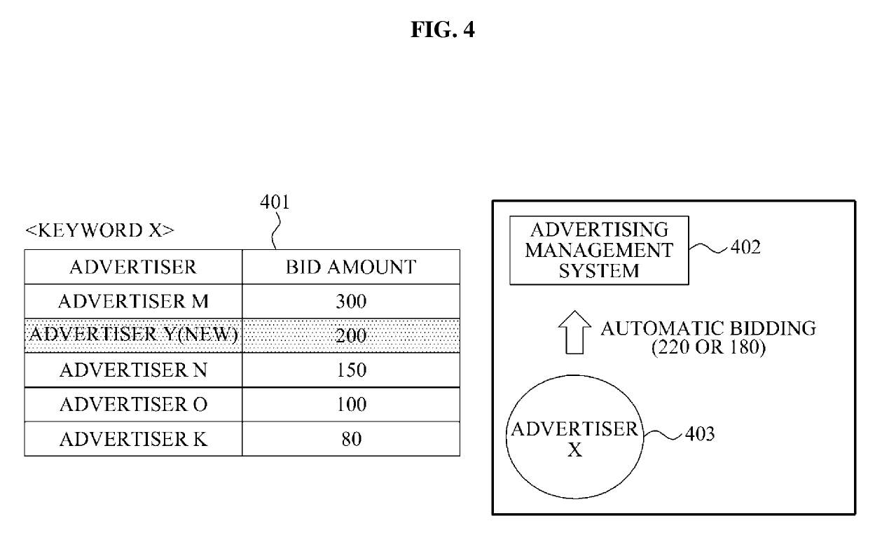

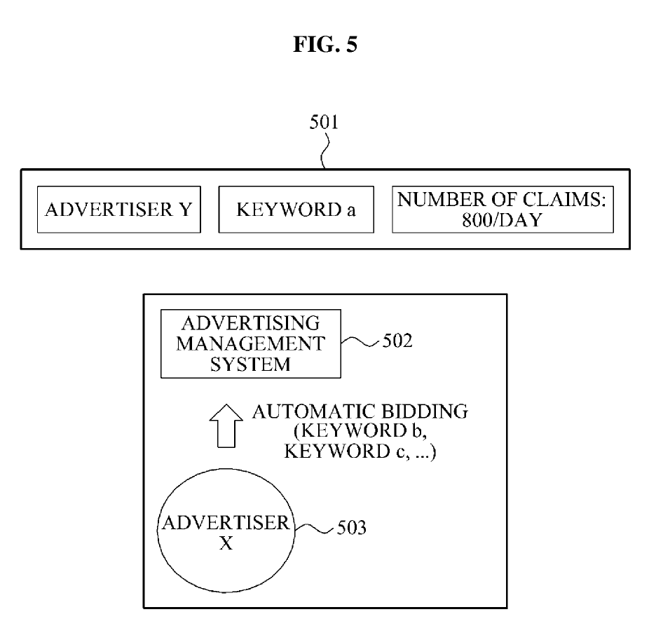

Operations of the bidding term modification unit 204 will be further described with reference to FIG. 4 and FIG. 5.

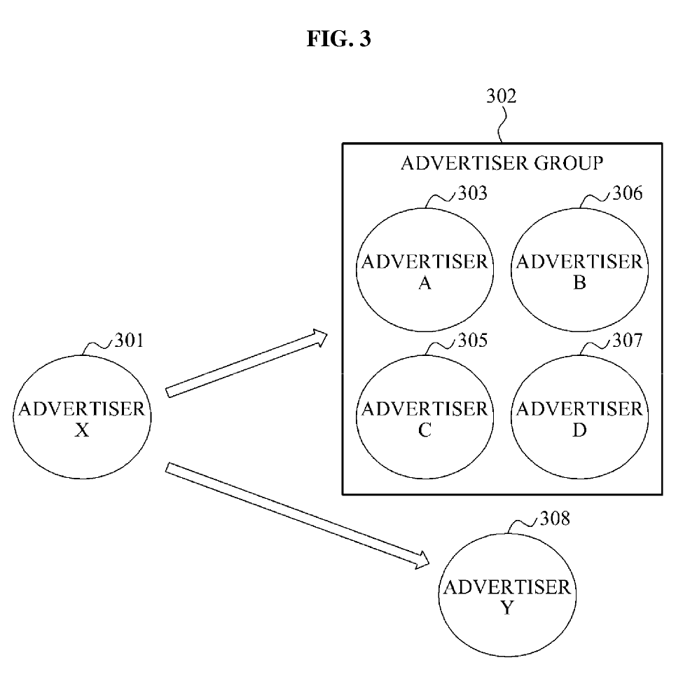

FIG. 3 is a diagram that illustrates a process of registering an advertiser or an advertiser group to be benchmarked according to an exemplary embodiment of the present invention.

In FIG. 3, advertiser X 301 may be an advertiser who has newly started an online advertisement or is inexperienced in advertising management. In response to a request of the advertiser X 301, an advertising management system may register an advertiser group 302 including advertiser A 303, advertiser B 306, advertiser C 305, and advertiser D 307. In response to a request of the advertiser X 301, the advertising management system may register advertiser Y 308.

The advertiser group 302 and the advertiser Y 308 may be benchmarking targets of the advertiser X 301. That is, the advertiser group 302 and the advertiser Y 308 may be advertisers who are experienced in managing online advertisements as compared to the advertiser X 301. Updated information about an advertising index of the advertiser group 302 and the advertiser Y 308 may be provided to the advertiser X 301. The advertiser X 301 may repeatedly place automatic bids based on the advertising index of the advertiser group 302 and the advertiser Y 308.

FIG. 4 is a diagram that illustrates a process of making automatic bids when an advertiser to be benchmarked newly places a bid for a keyword according to an exemplary embodiment of the present invention.

Referring to FIG. 4, an advertiser Y may be a benchmarking target of advertiser X 403. The advertiser Y may be an advertiser who is experienced in advertising management as compared to the advertiser X 403. In Table 401, it is assumed that the advertiser Y was newly bidding for a keyword X, offering a bid amount of 200. An advertising management system 402 may enable the advertiser X 403 to place automatic bids at an amount greater than or less than the bid amount offered by the advertiser Y by a certain rate. For example, when the certain rate is 10%, the advertising management system 402 may enable the advertiser X 403 to place automatic bids at a bid amount of 180 or 220.

In response to a modification of an advertising index of the advertiser Y, which is the target to be benchmarked, the advertising management system 402 may modify the bidding terms of the advertiser X 403. That is, the advertising management system 402 may enable the advertiser X 403 to repeatedly place automatic bids until the advertising index of the advertiser X 403 approaches the advertising index of the advertiser Y.

FIG. 5 is a diagram that illustrates a process of making automatic bids based on an advertising index of an advertiser to be benchmarked according to an exemplary embodiment of the present invention.

Referring to FIG. 5, an advertiser Y may be a benchmarking target of advertiser X 503. The advertiser Y may be an advertiser who is experienced in advertising management as compared to the advertiser X 503.

In Table 501, it is assumed that the number of daily clicks of the advertiser Y with respect to keyword “a” is 8000. An advertising management system 502 may enable the advertiser X 503 to repeatedly place automatic bids for a keyword associated with the keyword is “a” until the number of daily clicks of the advertiser X 503 approaches the number of daily clicks of the advertiser Y. The keyword associated with the keyword “a” may belong to the same category or have a similar relationship with the keyword “a”. That is, the advertising management system 502 may enable the advertiser X 503 to repeatedly place automatic bids for keywords “b”, “c”, and the like, associated with the keyword “a”, so that the number of daily clicks on an advertisement of the advertiser X 503 may approach 8000. In this example, the keywords “b” and “c” may be associated with a type of business of the advertiser X 503.

Even though only the number of registered keywords and the number of clicks are used as the advertising index in FIG. 4 and FIG. 5, the same scheme may be applied to the number of auctioned keywords, a PPC, a CTR, a purchase rate, and the like.

FIG. 6 is a flowchart that illustrates an advertising management method according to an exemplary embodiment of the present invention.

In operation S601, an advertising management system may register at least one of a second advertiser and/or an advertiser group to be benchmarked in association with advertising management of a first advertiser. For example, the advertising management system may register at least one of the second advertiser and/or the advertiser group in association with a type of business of the first advertiser.

The advertising management system may register the second advertiser or the advertiser group that satisfies the conditions for carrying out advertisement of the first advertiser. In this instance, the conditions for carrying out advertisement may be determined based on at least one of a monetary amount associated with the advertisement, a CTR, a purchase rate, and a PPC.

In operation S602, the advertising management system may provide the first advertiser with updated information about an advertising index of the second advertiser or the advertiser group. In this instance, the advertising management system may provide the updated information about the advertising index of the second advertiser or the advertiser group. The advertising index may be an index such as the number of registered keywords, the number of auctioned keywords, a CTR, the number of clicks, a purchase rate, and a PPC.

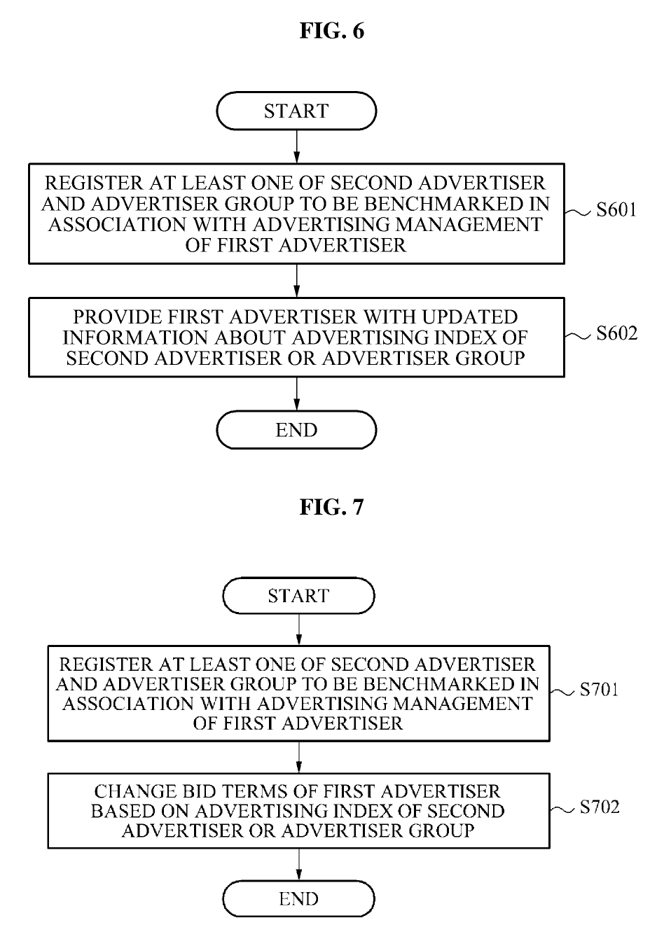

FIG. 7 is a flowchart that illustrates an advertising management method according to another exemplary embodiment of the present invention.

In operation S701, an advertising management system may register at least one of a second advertiser and/or an advertiser group to be benchmarked in association with advertising management of a first advertiser. For example, the advertising management system may register at least one of the second advertiser and/or the advertiser group in association with a type of business of the first advertiser.

The advertising management system may register the second advertiser or the advertiser group that satisfies the conditions for carrying out advertisement of the first advertiser. In this instance, the conditions for carrying out advertisement may be determined based on at least one of a monetary amount associated with the advertisement, a CTR, a purchase rate, and a PPC.

In operation S702, the advertising management system may modify the bidding terms of the first advertiser based on an advertising index of the second advertiser or the advertiser group. Here, the advertising index may be an index such as the number of registered keywords, the number of auctioned keywords, a CTR, the number of clicks, a purchase rate, and a PPC. The advertising management system may enable the first advertiser to place automatic bids until an advertising index of the first advertiser approaches the advertising index of the second advertiser or the advertiser group. For example, the advertising management system may enable the first advertiser to be bidding at an amount greater than or less than a bid amount offered by the second advertiser or the advertiser group by a certain rate. Also, the advertising management system may enable the first advertiser to repeatedly place automatic bids until the advertising index of the first advertiser with respect to a keyword associated with a type of business of the first advertiser approaches the advertising index of the second advertiser or the advertiser group.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to exemplary embodiments of the present invention, it is possible to provide convenience for advertising management by providing a beginner advertiser who is inexperienced in advertising management with an advertising index of an advertiser or an advertiser group to be benchmarked.

Also, according to exemplary embodiments of the present invention, it is possible to prevent a beginner advertiser who is inexperienced in advertising management from withdrawing from an advertising management system, and to enable the beginner advertiser to effectively operate an advertising by enabling the beginner advertiser to repeatedly place automatic bids based on an advertising index of an advertiser or an advertiser group to be benchmarked.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for managing advertisements, comprising:
one or more non-transitory computer readable storage devices comprising a registration unit and an updated information providing unit;
wherein the registration unit is configured to register a second advertiser to be benchmarked in association with advertising management of a first advertiser, and
the updated information providing unit is configured to provide the first advertiser with updated information about an advertising index of the second advertiser.

2. The system of claim 1, wherein the registration unit is configured to register the second advertiser in association with a type of business of the first advertiser.

3. The system of claim 1, wherein:
the registration unit is configured to register the second advertiser that satisfies a condition for carrying out advertisement of the first advertiser, and
the condition for carrying out the advertisement is determined based on at least one of a monetary amount associated with the advertisement, a click through rate (CTR), a purchase rate, and a pay per click (PPC).

4. The system of claim 1, wherein the updated information providing unit is configured to provide the updated information about the advertising index of the second advertiser, the advertising index comprising at least one of the number of registered keywords, the number of auctioned keywords, a CTR, the number of clicks, a purchase rate, and a PPC.

5. The system of claim 1, wherein the updated information providing unit is configured to provide the updated information about the advertising index of an advertiser group comprising the second advertiser.

6. A system for managing advertisements, comprising:
one or more non-transitory computer readable storage devices comprising a registration unit and a modification unit;
wherein the registration unit is configured to register a second advertiser to be benchmarked in association with advertising management of a first advertiser, and
the modification unit is configured to modify a bidding term of the first advertiser based on an advertising index of the second advertiser.

7. The system of claim 6, wherein:
the registration unit is configured to register the second advertiser that satisfies a condition for carrying out advertisement of the first advertiser, and
the condition for carrying out the advertisement is determined based on at least one of a monetary amount associated with the advertisement, a click through rate (CTR), a purchase rate, and a pay per click (PPC).

8. The system of claim 6, wherein:
the advertising index comprises at least one of the number of registered keywords, the number of auctioned keywords, a CTR, the number of clicks, a purchase rate, and a PPC, and
the modification unit is configured to enable the first advertiser to place an automatic bid when an advertising index of the first advertiser does not match the advertising index of the second advertiser.

9. The system of claim 6, wherein the modification unit is configured to modify a bidding term of the first advertiser based on an advertising index of an advertiser group comprising the second advertiser.

10. A method for managing advertisements using a processor, comprising:
registering a second advertiser to be benchmarked in association with advertising management of a first advertiser;
updating information about an advertising index of the second advertiser using the processor; and
providing the first advertiser with the updated information about the advertising index of the second advertiser.

11. The method of claim 10, wherein the registering comprises registering the second advertiser in association with a type of business of the first advertiser.

12. The method of claim 10, wherein:
the registering comprises registering the second advertiser that satisfies a condition for carrying out advertisement of the first advertiser, and
the condition for carrying out the advertisement is determined based on at least one of a monetary amount associated with the advertisement, a click through rate (CTR), a purchase rate, and a pay per click (PPC).

13. The method of claim 10, wherein the providing comprises providing the updated information about the advertising index of the second advertiser, the advertising index comprising at least one of the number of registered keywords, the number of auctioned keywords, a CTR, the number of clicks, a purchase rate, and a PPC.

14. A method for managing advertisements using a processor, comprising:
registering a second advertiser to be benchmarked in association with advertising management of a first advertiser; and
modifying, using the processor, a bidding term of the first advertiser based on the advertising index of the second advertiser.

15. The method of claim 14, wherein:
the registering comprises registering the second advertiser that satisfies a condition for carrying out advertisement of the first advertiser, and
the condition for carrying out the advertisement is determined based on at least one of a monetary amount associated with the advertisement, a click through rate (CTR), a purchase rate, and a pay per click (PPC).

16. The method of claim 14, wherein:
the advertising index comprises at least one of the number of registered keywords, the number of auctioned keywords, a CTR, the number of clicks, a purchase rate, and a PPC, and
the modifying comprises enabling the first advertiser to place an automatic bid when an advertising index of the first advertiser does not match the advertising index of the second advertiser.

17. A non-transitory computer-readable medium comprising a program for instructing a computer to perform the method of claim 10.

18. A method for managing advertisements using a processor, comprising:
receiving a request from a first advertiser for provision of information on a reference advertiser in association with advertising management of the first advertiser;
registering the reference advertiser;
updating information about an advertising index of the reference advertiser using the processor; and
providing the first advertiser with the updated information about the advertising index of the reference advertiser.

19. The method of claim 18, wherein the registering comprises registering the reference advertiser in association with a type of business of the first advertiser.

20. The method of claim 18, wherein:
the registering comprises registering the reference advertiser that satisfies a condition for carrying out advertisement of the first advertiser, and
the condition for carrying out the advertisement is determined based on at least one of a monetary amount associated with the advertisement, a click through rate (CTR), a purchase rate, and a pay per click (PPC).

21. The method of claim 18, wherein the providing comprises providing the updated information about the advertising index of the reference advertiser, the advertising index comprising at least one of the number of registered keywords, the number of auctioned keywords, a CTR, the number of clicks, a purchase rate, and a PPC.
